(19) United States
(12) Patent Application Publication
(10) Pub. No.: US 2013/0212355 A1
(43) Pub. Date: Aug. 15, 2013

(54) Conditional vector mapping in a SIMD processor

(71) Applicant: Tibet Mimar, Sunnyvale, CA (US)

(72) Inventor: Tibet Mimar, Sunnyvale, CA (US)

(21) Appl. No.: 10/357,805

(22) Filed: Feb. 3, 2003

Related U.S. Application Data
(60) Provisional application No. 60/354,368, filed on Feb. 4, 2002.
(60) Provisional application No. 60/364,315, filed on Mar. 14, 2002.
(60) Provisional application No. 60/385,648, filed on Jun. 3, 2002.
(60) Provisional application No. 60/397,669, filed on Jul. 22, 2002.

(51) Int. Cl. G06F 9/30

(52) U.S. Cl. CPC G06F 9/30036
USPC 712/5

(57) ABSTRACT

The present invention provides a method for mapping input vector register elements to output vector register elements in one step in relation to a control vector register controlling vector-to-vector mapping and condition code values. The method includes storing an input vector having N-elements of input data in a vector register and storing a control vector having N-elements in a vector register, and providing for enabling vector-to-vector mapping where the mask bit is not set to selectively disable. The masking of certain elements is useful to partition large mappings of vectors or matrices into sizes that fits the number of elements of a given SIMD, and merging of multiple mapped results together. This method and system provides a highly efficient mechanism of mapping vector register elements in parallel based on a user-defined mapping and prior calculated condition codes, and merging these mapped vector elements with another vector using a mask.

### CROSS-REFERENCE TO RELATED APPLICATIONS

This application claims priority under 35 U.S.C 119(e) from co-pending U.S. Provisional Application No. 60/354,368 filed on Feb. 4, 2002 by Tibet Mimar entitled “Flexible Method of Mapping of Vector Register Elements”, and from co-pending U.S. Provisional Application No. 60/364,315 filed on Mar. 14, 2002 by Tibet Mimar entitled “Vision Processor”, the subject matter of which is fully incorporated herein by reference.

This application is related to our corresponding Provisional Patent Application (PPA) Ser. No. 60/385,648 entitled “Method For Fast And Flexible Scan Conversion And Matrix Transpose In A SIMD Processor” filed on Mar. 6, 2002 by the present inventor.

This application is related to our corresponding Provisional Patent Application (PPA) Ser. No. 60/397,669 entitled “Method For Efficient Handling of Vector High-Level Language Conditional Constructs In A SIMD Processor” filed on Jul. 22, 2002 by the present inventor.

### BACKGROUND OF THE INVENTION

1. Field of the Invention

The invention relates generally to the field of processor chips and specifically to the field of single-instruction multiple-data (SIMD) processors. More particularly, the present invention relates to multiplexing and mapping of vector elements in a SIMD processing system.

2. Description of the Background Art

Today, SIMD processors are gaining acceptance due to their ability to meet high-performance requirements for video processing, including audio and video data compression and decompression. These and other similar digital signal processing applications in communications, such as Asymmetric Digital Subscriber Line (ADSL) modems, require greater speed and data handling capabilities than previous applications. There are some data handling operations that require arbitrary mapping of vector elements. These operations do not affect individual elements by processing, but rather affect their location or mapping of the overall elements of a vector. For example, a matrix transpose operation interchanges the rows with the columns of a two-dimensional (2-D) matrix of data elements. Similarly, a zig-zag operation that is commonly used by all video compression algorithms, variations of the zig-zag operation, and its inverse zig-zag operation, all require manipulation of the relative position of vector elements. In the absence of a processor vector operation (instruction) to handle these operations in parallel, there is a need to handle these operations either by a special-purpose hardware block, or by sequential programmed instructions without benefit of additional hardware, handling each element one-by-one.

One of the reasons that today's SIMD processors are limited to vectors of eight or sixteen elements is that there has been no efficient and general way to provide for an effective manipulation of vector elements, and at the same time provide for masking of selected output elements. Furthermore, no conditional mapping based on a combination of condition flags is provided for today. This meant that the conditional operations, required branch instructions, and had to be performed one-by-one, without the efficiency of parallelism, unless special vector instructions for a processor were provided for each of these operations. Branch instructions typically require several processor-clock cycle periods in order to execute, because the instruction pipeline must be flushed and then loaded with new instructions, in order to execute the branch. The processor efficiency is thus reduced, thereby reducing overall processor performance. Accordingly there is a need for the present invention.

### SUMMARY OF THE INVENTION

The present invention provides a method for mapping elements of an input vector register to elements of an output vector register, where the mapping is defined by another vector register, in a SIMD processor system. By requiring fewer processor-clock cycles in order accomplish many vector-element data and matrix-element data arrangement chores, relative to other methods, the present invention effectively increases SIMD processor performance. A control vector register controls the mapping of input elements and masking of certain elements. Each element of the control vector register contains a field, which specifies the element number of the input vector register to map to that element, and also contains a mask bit to selectively leave that element unchanged. A condition code flag (condition flag in short) or combination of flags is chosen by the instruction that performs such vector-to-vector mapping, and these condition codes are checked for each element position, and if true, then the mapping operation is enabled for that vector position, if the mask bit for that vector element position is not set.

### BRIEF DESCRIPTION OF THE DRAWINGS

The accompanying drawings, which are incorporated and form a part of this specification, illustrate prior art and embodiments of the invention, and together with the description, serve to explain the principles of the invention.

FIG. 1 shows a high-level view of the present invention.

FIG. 2 illustrates the operation of mapping source vector elements to output vector elements, specified by the contents of a control vector register. This figure shows a SIMD processor with N elements per vector register.

FIG. 3 shows the details of mask and condition code flags that enable or disable the mapping of each output vector element.

FIG. 4 shows opcode of the VMUX instruction.

FIG. 5 shows a specific example of mapping for an embodiment with 8 elements per vector and 16 bits per vector element. In this figure, bits 0 to 2 of each control vector elements specify the mapping index and bit 15 functions as a mask to disable storing of the mapping result in the destination vector register, when set to one. The values are shown in hexadecimal notation, as indicated by the “0x” prefix.

FIG. 6 shows an example of conditional vector mapping for 32 vector element embodiment.

### DETAILED DESCRIPTION

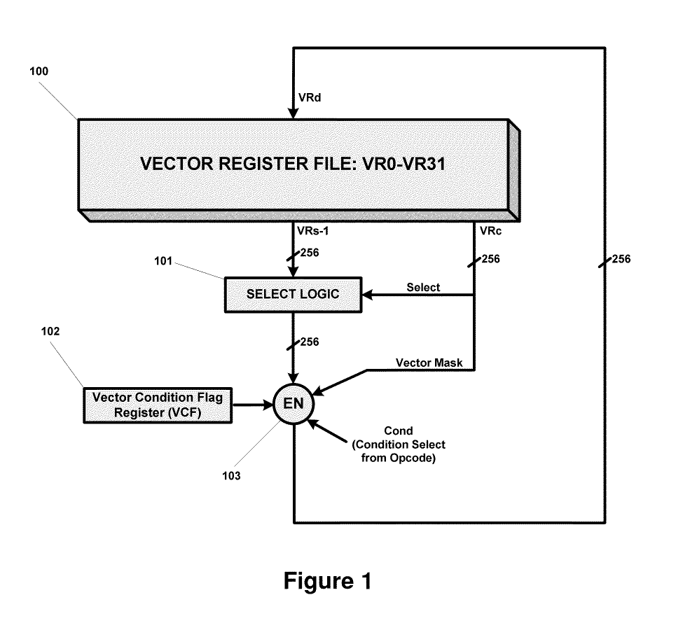

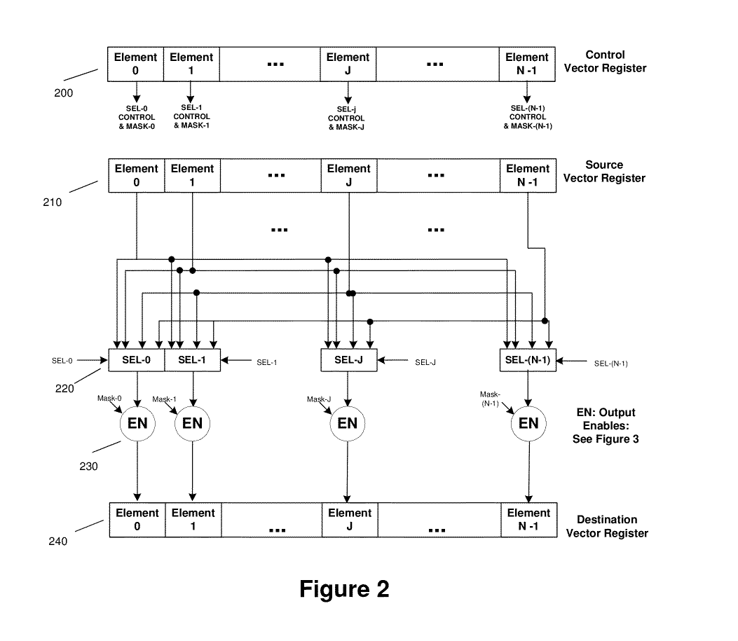

FIGS. 1 and 2 illustrate the mapping of vector elements. VMUX instruction provides a way to map elements of an input vector register to elements of an output vector register, where the mapping is defined by another vector register. Each element of the vector register that controls mapping specify the element number of the input vector register to map to this element, and also a mask bit to leave that element unchanged. A condition code flag or combination of flags 102 is optionally chosen by the instruction that performs this vector-to-vector mapping, and these condition codes are checked for each element position, and if true, then the mapping 101 operation is enabled for that vector position, if the mask bit is not set. The applications include zigzag scan, general mapping of vector elements, and conditional merging of vector elements.

VMUX is the vector multiplex instruction of present invention, which performs arbitrary mapping of input matrices and vectors to output matrices and vectors in one instruction. One embodiment of a SIMD mapping instruction uses a source-vector register (VRs), a mapping control vector register (VRc), and destination vector register (VRd), as:
VMUX.<CC> VRd, VRs, VRc
   Where “CC” specifies the condition codes, if the mapping is to be enabled based on each element's condition code flags 102. If condition code flags are not used, then the condition “True” may be used from the list of conditions, or simply omitted. The source and destination vector registers, VRd and VRs, are part of a vector register file 100. VRc is part of the same vector register file, or sourced from an alternate vector register file. FIG. 1 shows an embodiment where all source and control vectors are sourced from the same vector register file 100.

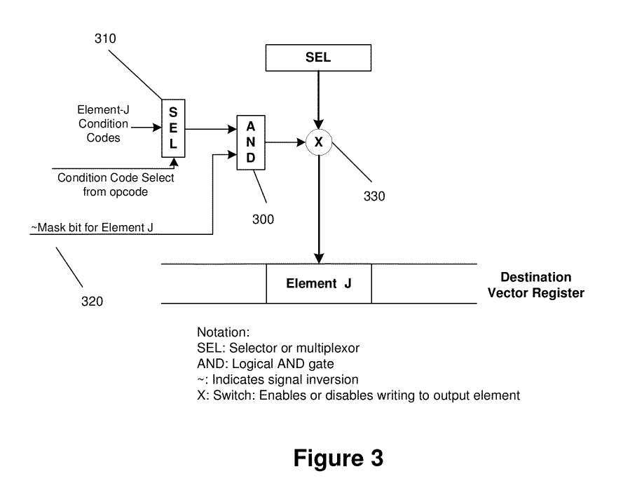

For an N-element SIMD processor log₂(N) bits are required in order to specify the mapping for each output element. For example, for a vector register of 32 elements, five bits are needed to specify the mapping. This mapping field is part of each element of the control vector register 200. Each element of the control vector register also includes a mask bit 320, which selectively disables storing the mapping result as shown in FIG. 3, for a given element, in each corresponding destination vector register element position. We could assign the location of bit fields within control elements, to specify mapping and the mask bit in multiple ways, but in one embodiment using 16-bit elements and 32 elements per vector, the following control vector element specification is used:

Bits 4 to 0: Mapping Field: Indicates which numbered input element of the source vector register is mapped to the destination vector register element.

### Bits: 14 to 5: Unused.

Bit 15: Mask: When set to one, this bit disables write-back of the mapping result in the corresponding destination vector register element.

In each numbered control vector register element, the mapping value specified for each correspondingly numbered output element controls the correspondingly numbered selector 220, which selects the specified source element from the source vector register 210. The mask bit 320 for a given element in the control vector register will disable the write-back stage of the instruction pipeline for that the corresponding destination element, when the mask bit is set to a value of one. As shown in FIG. 3, the output enable logic 330 is not only controlled by mask bit 320, but a logical AND of the inverted mask bit and a selected combination of condition code flags 310 for that element position. The selector 310 could be defined to select a single condition code, or a combination of condition codes, and the resultant one or more selected condition bits are AND'd together at 300 with the inverted mask bit. If the logical result at 330 of this AND is false, the writing of mapping for that output element in the destination vector register is disabled, and so the destination vector register (output) element remains unchanged. This masking capability is useful for conditional or unconditional merging of multiple vector register elements, with the advantage of not requiring any flow control instructions to accomplish the merging.

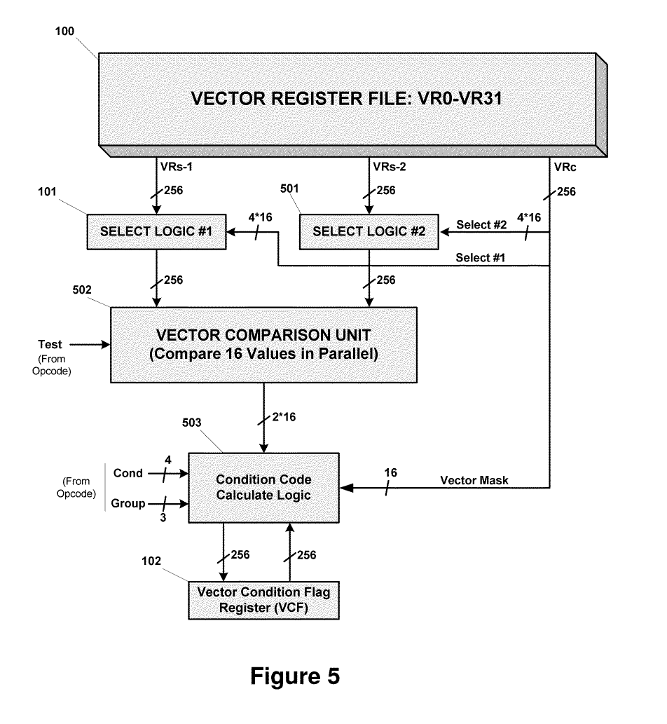

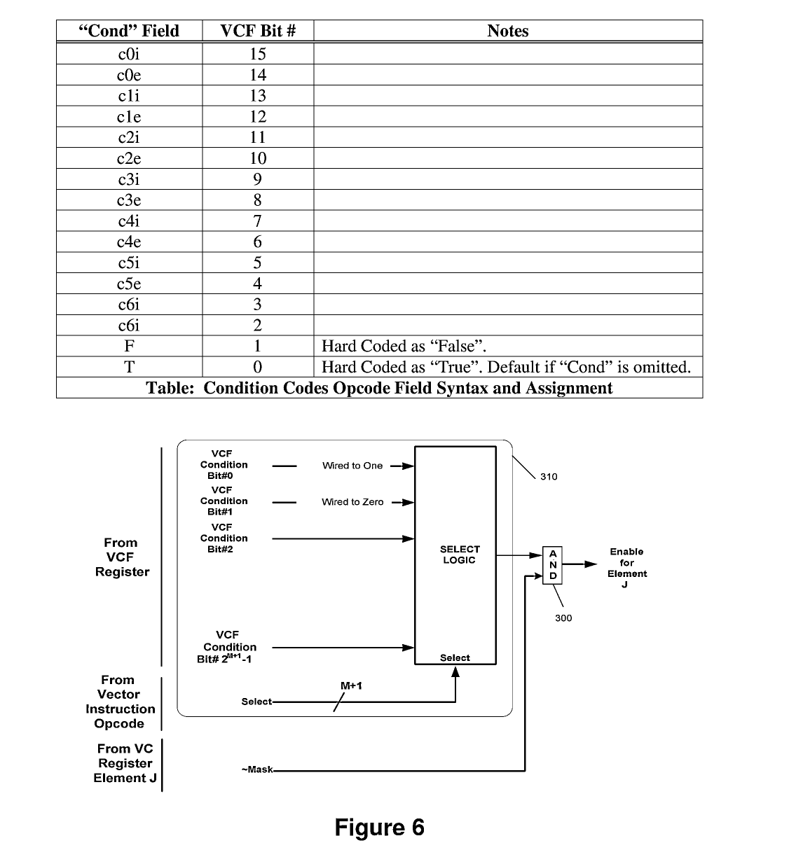

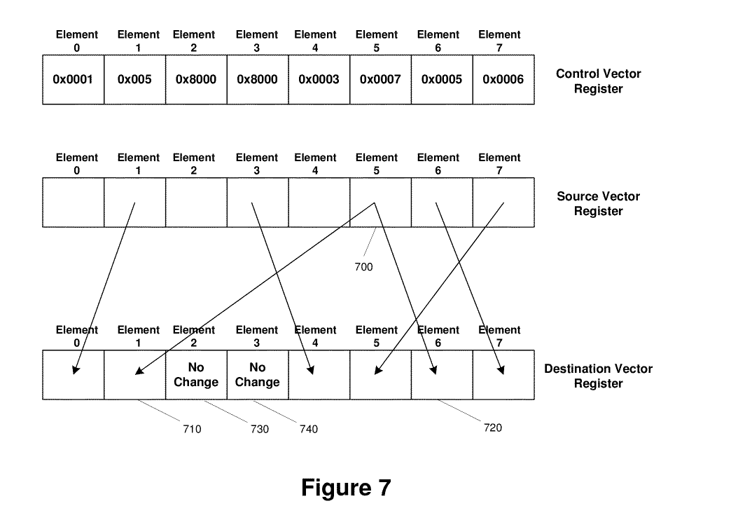

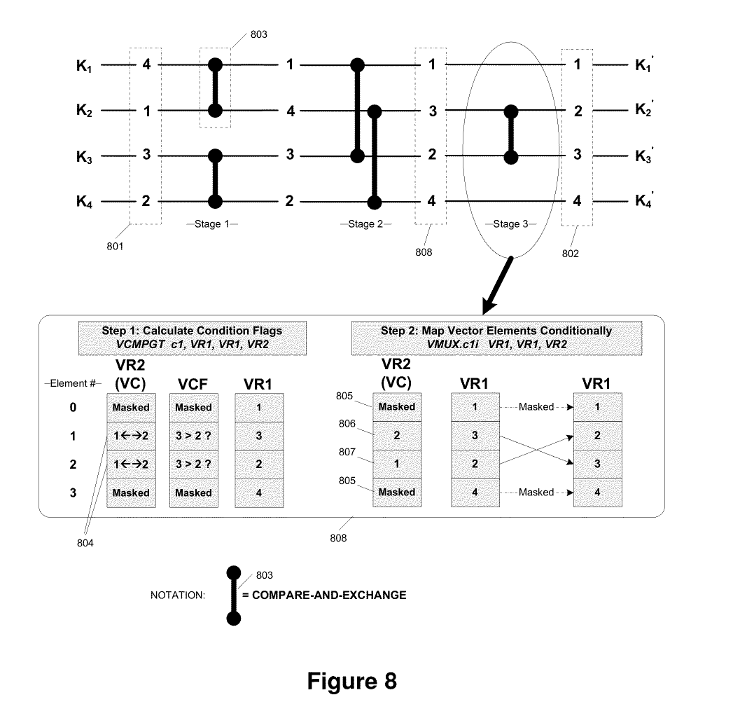

FIG. 5 shows an example of mapping for the case of an 8-element SIMD processor with 16-bit elements, and without using condition codes. Note that one input source vector element of source vector register could be mapped to multiple output control vector register elements at 510 and 520 for example. Also, when bit #15 is set, no change of the corresponding output element occurs, e.g., 530 and 540; the corresponding destination vector register element is not written. FIG. 6 illustrates a similar example for a 32-element per vector register embodiment.

Condition codes depend on the particular implementation. One possible embodiment is shown in Table 1. The Condition Code bits are calculated by other SIMD instructions as follows in general with some exceptions:

N: Set if result is negative, cleared otherwise; Z: Set if result is zero, cleared otherwise. This bit does not include any testing of carry bit;
V: Set if overflow is generated, cleared otherwise. This bit carries significance only for signed operands;
C: Set if carry is generated, cleared otherwise. In a subtract or compare operation, this bit is set if no borrow is generated;
X: Set if carry is generated, cleared otherwise. In a subtract or compare operation, this bit is set if no borrow is generated.
In general for this embodiment, a vector-compare or vector-test instruction is used to set a condition flag for each vector position. Each vector element could also have multiple condition flags, where each flag is an aggregate of the above conditions. For example, testing for elements of one vector “higher” than the other requires the processing to take into account using (C & !Z)) by the processing element. This means that a carry is set and result is not zero, i.e., Zero bit is not set. This aggregate condition will set a single condition code flag for each vector position. The CC field of the VMUX instruction will choose one of these pre-calculated condition code flags 102, including always-true and always-false conditions.

TABLE 1
An Example of Condition Code Combinations

| | | Signed/ |
|---|---|---|
| Condition | Test | Unsigned |
| False | 0 | Both |
| Carry Clear | !C | Unsigned |
| (Lower) | | |
| Carry Set | C | Unsigned |
| (Higher or Same) | | |
| Equal | Z | Both |
| Greater or Equal | (N&V) + (!N&!V) | Signed |
| Greater Than | (N&V&Z) + | Signed |
| | (!N&!V&!Z) | |
| Higher Than | C&!Z | Unsigned |
| Less or Equal | Z + (N&!V) + | Signed |
| | (!N&V) | |
| Lower or Same | !C + Z | Unsigned |
| Less Than | (N&!V) + (!N&V) | Signed |
| Minus | N | Signed |
| Not Equal | !Z | Both |
| Plus | !N | Signed |
| True | 1 | Both |
| Overflow Clear | !V | Signed |
| Overflow Set | V | Signed |

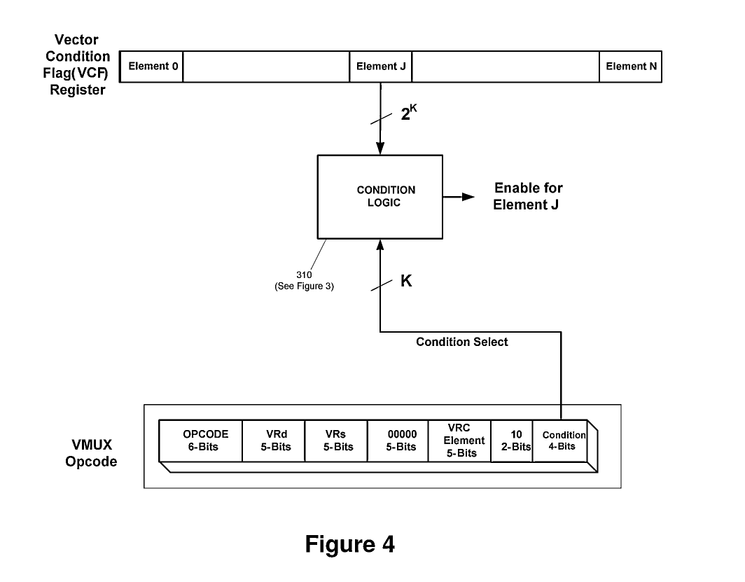

The opcode format is shown in FIG. 4 for 32 elements, but is extensible to 64-element SIMD using the reserved bits (RSV). Each element size is 16 bits.
The “cc” specifies the condition codes, if the mapping is to be enabled based on each element's condition code flags. If condition code flags are not to be used, then the condition “True” could be used, or this is omitted from assembly syntax.
VRd is the destination vector register, and VRs-1 and VRs-2 are the vector source registers. Not all instructions require two source and one-destination operands, but this represents the general forth.

1.-51. (canceled)

52. A method for performing vector operations in parallel in one step, the method comprising the steps of:
providing a vector register file including a plurality of vector registers;
storing a first input vector in said vector register file;
storing a control vector in said vector register file, wherein said control vector is selected as a source operand of said vector operations;
selecting a condition flag from a plurality of condition flags for each vector element position in accordance with a condition select field from a vector instruction, said plurality of condition flags are derived from results of executing a prior instruction sequence;
mapping the elements of said first input vector to the elements of a first output vector, in accordance with a first field of respective element of said control vector; and
storing elements of said first output vector on an element-by-element basis conditionally, if mask bit of respective element of said control vector is interpreted as false and in accordance with respective said selected condition flag,
wherein said vector operations are performed in parallel in one instruction.

53. The method of claim 52, wherein one of said plurality of condition flags for each respective vector element position is defined as always true.

54. (canceled)

55. (canceled)

56. The method of claim 52, wherein each of said first input vector, said second input vector, said first output vector, said second output vector, and said control vector each have N vector elements.

57. The method of claim 56, wherein the number of said N vector elements is selected from the group consisting of {8, 16, 32, 64, 128, 256}.

58. The method of claim 56, wherein the number of said N vector elements is an integer value between 2 and 256, and each vector element is a fixed-point integer or a floating-point number.

59. An apparatus for performing vector operations in parallel in accordance with a control vector register and condition flags, the apparatus comprising:
a vector register file including a plurality of vector registers with a plurality of read data ports and at least one write data port, wherein some of said plurality of vector registers are accessed in parallel and at the same time, said control vector register is part of said vector register file;
a vector condition flag register for storing a plurality of condition flags for each vector element position, each element of said plurality of condition flags defining a true or false condition value, and a condition select logic that selects one of a plurality of condition flags for each vector element position in accordance with a condition select field from a vector instruction;
a first select logic coupled to said vector register file for mapping elements of a first vector register in accordance with said control vector register; and
an enable logic coupled to output of said first select logic for controlling storing elements of an output vector register in said vector register file on an element-by-element basis in accordance with a user-defined mask bit for each vector element position of said control vector register and output of said condition select logic for each vector element position,
wherein said vector operations are performed in parallel by one instruction.

60. The apparatus of claim 59, wherein one of said plurality of condition flags for each vector element position of said vector condition flag register is hard wired to always true.

61. (canceled)

62. (canceled)

63. The apparatus of claim 59, wherein each element of a vector register is a floating-point number or a fixed-point integer.

64. The apparatus of claim 59, wherein all vector registers have N vector elements, N being an integer value between 2 and 256.

65. A method for performing vector operations in parallel in one step, the method comprising:
storing a first input vector;
storing a control vector;
selecting a condition flag from a plurality of condition flags for each vector element position, said plurality of condition flags are derived from results of executing a prior instruction sequence;
mapping the elements of said first input vector to the elements of a first output vector, in accordance with a first field of respective element of said control vector; and
storing elements of said first output vector on an element-by-element basis conditionally in accordance with mask bit of respective element of said control vector is interpreted as false and in accordance with respective said selected condition flag, wherein one of said plurality of condition flags for each respective vector element position is defined as always true.
